(19) United States
(12) Patent Application Publication
(10) Pub. No.: US 2006/0265481 A1
(43) Pub. Date: Nov. 23, 2006

(54) Systems and methods for providing features and user interfaces therefor in network browsing applications

(75) Inventors: Edward Seitz, Atlanta, GA (US); Derrick Whittle, Marietta, GA (US); Robert Gue, Atlanta, GA (US); Stephen Owens, Marietta, GA (US); Brockton Davis, Marietta, GA (US); James Bollas, Columbus, OH (US); Michael Wolford, Roswell, GA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/434,893

(22) Filed: May 17, 2006

Related U.S. Application Data
(60) Provisional application No. 60/681,458, filed on May 17, 2005.

(51) Int. Cl. G06F 15/177

(52) U.S. Cl. 709/222

(57) ABSTRACT

A method and user interfaces for permitting a user to define and edit a set of web sites to be loaded when a network browsing application is loaded. This allows the user to easily keep track of the latest changes to one or more of the user's favorite web sites, to track the status of corporate information, or the like. The set of web sites can be individually controlled, or an administrator or other entity may specify at least a subset of the set of web sites to be loaded.

This application claims the benefit of U.S. Provisional Application Ser. No. 60/681,458 filed May 17, 2005 entitled “Systems and Methods for Providing Features and User Interface in Network Browsing Applications”, the disclosure and contents of which are incorporated herein by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates in general to the field of network browsing-enabled applications, and in particular to systems and methods that provide improved interfaces such network browsing-enabled applications.

### BACKGROUND

The Internet allows users to access a vast amount of data covering a wide variety of topics. Although users may bookmark or otherwise store a list of Internet sites containing data of interest, such data is typically not needed, or even desired, on a regular basis. That is, the users bookmark the sites knowing, or at least hoping, that the data will be accessible when needed. Instead, most users tend to only visit a handful of sites with any regularity. Some technologies, such as RSS feeds, allow users to easily track the latest changes to their favorite sites, but many users simply prefer to visit the site itself periodically. Where more than one or two sites are regularly visited, however, it can be cumbersome to type in the uniform resource locator (“URL”) or other link to the site. In addition, although it is possible to organize bookmarks and the like to facilitate faster access to the user's favorite sites, such organization can be time consuming.

What is needed are improved systems and methods for allowing users to readily access their favorite or most frequently visited sites, and improved user interfaces therefor.

### SUMMARY

Accordingly, the instant disclosure is directed to systems and methods for providing improved features to a network browsing application and user interfaces therefor that substantially obviate one or more of the problems due to limitations and disadvantages of the related art.

The instant disclosure provides a method of initializing the contents of a browsing application running on a client, the method comprising receiving from a user a request to initiate a browsing application; receiving a set of predefined web sites to be loaded into the browsing application; and loading at least a subset of the set of predefined web sites into the browsing application. The set of predefined web sites may be received locally from a client, from a central server, or a combination thereof, and may be received as a portion of an XML data feed. At least a subset of the predefined web sites can then be loaded into the network browsing application, and may be loaded as tabs within a single browsing application window or as a plurality of browsing application windows. The set of predefined web sites may be generic, such that multiple users receive the same set of web sites, or may be individualized for a given user based on the user's identity. The user's identity can be provided by the client, by the browsing application, or by one or more programs associated with the browsing application and/or the client. The user can also request that the plurality of predefined web sites be loaded at any time while the browsing application is running.

The instant disclosure also provides a method of loading a plurality of web sites into a browsing application running on a client, the method comprising receiving a plurality of predefined web sites to be loaded into the browsing application, receiving from a user a request to load the plurality of predefined web sites into the browsing application, and loading at least a subset of the plurality of predefined web sites into the browsing application. The set of predefined web sites may be received locally from a client, from a central server, or a combination thereof, and may be received as a portion of an XML data feed. At least a subset of the predefined web sites can then be loaded into the network browsing application, and may be loaded as tabs within a single browsing application window or as a plurality of browsing application windows. The set of predefined web sites may be generic, such that multiple users receive the same set of web sites, or may be individualized for a given user based on the user's identity. The user's identity can be provided by the client, by the browsing application, or by one or more programs associated with the browsing application and/or the client. The user can also request that the plurality of predefined web sites be loaded at any time while the browsing application is running.

The instant disclosure still further provides a computer-readable storage medium containing a set of instructions for a general purpose computer for initializing the contents of a browsing application running on a client, comprising code for receiving from a user a request to initiate a browsing application, code for receiving a set of predefined web sites to be loaded into the browsing application, and code for loading at least a subset of the set of predefined web sites into the browsing application. The set of predefined web sites may be received locally from a client, from a central server, or a combination thereof, and may be received as a portion of an XML data feed. At least a subset of the predefined web sites can then be loaded into the network browsing application, and may be loaded as tabs within a single browsing application window or as a plurality of browsing application windows. The set of predefined web sites may be generic, such that multiple users receive the same set of web sites, or may be individualized for a given user based on the user's identity. The user's identity can be provided by the client, by the browsing application, or by one or more programs associated with the browsing application and/or the client. The set of instruction for a general purpose computer may also include code whereby the user can also request that the plurality of predefined web sites be loaded at any time while the browsing application is running.

The instant disclosure also provides a user interface for facilitating the transfer of content between a plurality of devices, comprising first code for presenting a network browsing application on a first device, wherein the first code permits a user of the network browsing application to identify a web site to be added to a start groups list; second code for causing the web site to be added to the start groups list associated with the user; and, third code for causing the network browsing application to load at least a list of the web sites contained in the start groups list associated with the user, whereby the user can edit the contents of the start groups list. The edits the user can make may include, without limitation, adding, removing, reordering, renaming, and changing the URL associated with the web sites in start groups list. However, in an embodiment, the user may be prevented from editing at least a subset of the web sites in the start groups list.

Additional features and advantages will be set forth in the description which follows, and in part will be apparent from the description, or may be learned by practice of the disclosure. The objectives and other advantages will be realized and attained by the structure particularly pointed out in the written description and claims hereof as well as the appended drawings.

It is to be understood that both the foregoing general description and the following detailed description are exemplary and explanatory and are intended to provide further explanation of the disclosed embodiments.

### BRIEF DESCRIPTION OF THE FIGURES

The accompanying drawings, which are included to provide a further understanding of the disclosed embodiments and are incorporated in and constitute a part of this specification and, together with the description, serve to explain the principles of at least one embodiment.

In the drawings:

FIG. 1 is a screen capture of an exemplary network browsing application user interface.

FIG. 2 is a screen capture of an alternative exemplary network browsing application user interface.

FIG. 3 is a screen capture of an exemplary network browsing application user interface through which start groups can be edited.

FIG. 4 is a block diagram of an exemplary network architecture supporting the features and user interfaces of at least one embodiment.

FIG. 5 is a flow diagram illustrating an exemplary method through which start groups can be loaded by a network browsing application.

### DETAILED DESCRIPTION OF EMBODIMENTS

Reference will now be made in detail to embodiments, examples of which are illustrated in the accompanying drawings.

The disclosed embodiments relate to improved functionality and user interface features for network browsing-enabled applications. Such applications, referred to herein as “browsing applications,” include, e.g., internet browsers, mail programs with browsing capabilities, file-sharing applications, content aggregators, and any application which provides the capability to browse resources either on an external network (e.g., the internet) or an internal network. Such applications may be separate from or integrated into an operating system.

The functionality of the embodiments described herein can be provided in the form of add-ons or plug-ins to an existing browsing application such as a web browser, but can alternatively be provided in the form of features written into a browsing application at the application's source code level. In certain embodiments, one or more of the features or functionality described below are provided as a compiled .dll file or series of compiled .dll files which are loaded at startup or runtime in connection with an existing browsing application so as to provide an improved user interface and/or additional functionality to the browsing application. As is set forth in further detail below, one or more of the features or functionality described below can be provided or customized by a feed such as an XML feed which is delivered to the browser upon the occurrence of a triggering event. Such triggering events include, e.g., the loading of the browser into the operating system, a change in user-specific parameters, a time of day, or the like. For load-balancing or other purposes, the triggering of download of the feed can be limited to a certain number of times per day, hour, minute, etc. The triggering event can occur on the client or on a server, and the feed can be requested by the client or pushed to the client from a server. In this respect, “client” as used herein can be either a client browsing application such as a web browser or a client machine in general. An example of such an XML feed is provided in Appendix A and discussed in further detail below.

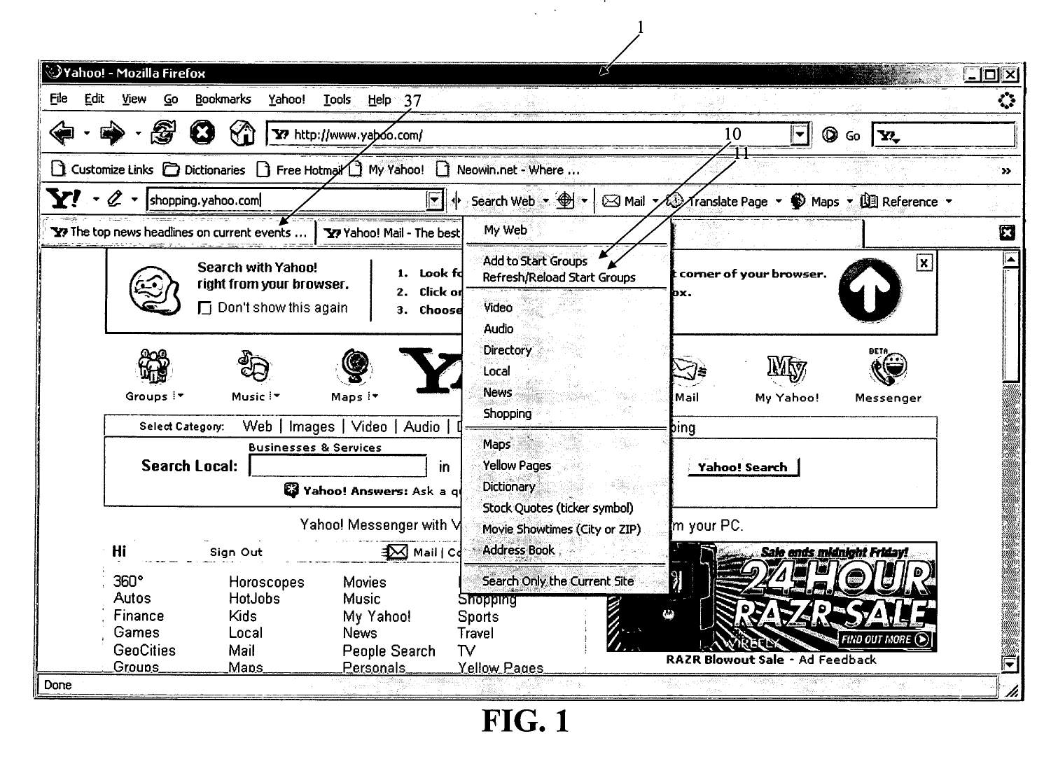

FIG. 1 is a screen capture of an exemplary browsing application 1 which includes processes that display a start group, which is a list of pages to open in a browsing application 1 at startup of the application, or when requested by the user choosing an appropriate menu choice 11 or otherwise interacting with browsing application 11. As can be seen in the figure, the user's predefined start group pages can be associated with a separate tab in a series of tabs 37 by browsing application 1, and browsing application 1 can allow the user to click on or otherwise select one of the tabs 37 to display the associated page. In one embodiment, rather than loading individual tabs, the start group pages can be loaded in separate windows of browsing application 1.

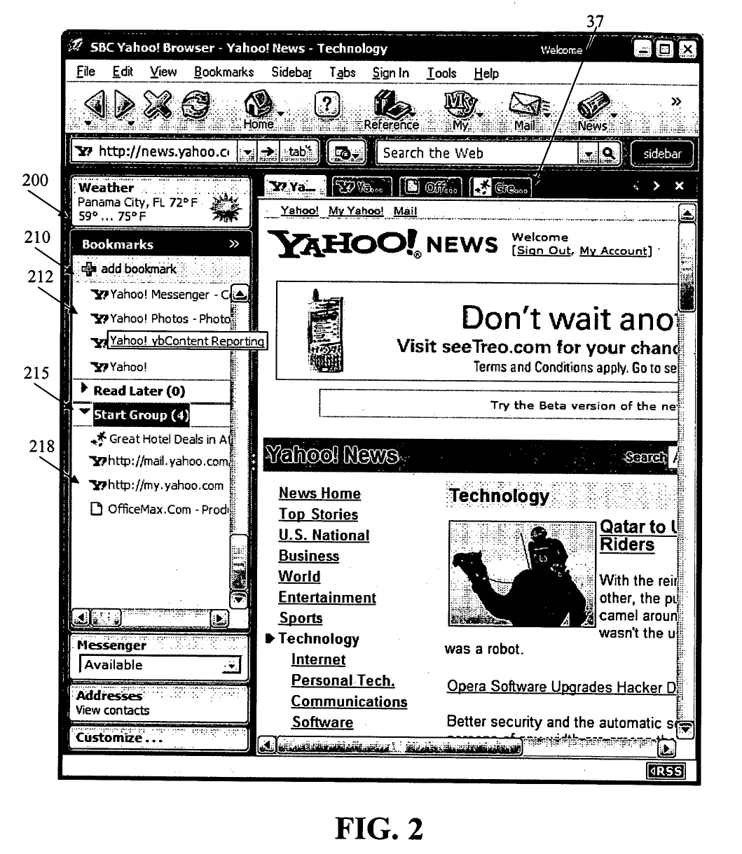

FIG. 2 is a screen capture of an alternative embodiment of browsing application 1 illustrating additional start group user interfaces. FIG. 2 illustrates the user's start groups opened within browsing application 1 as tabs 37. Browsing application 1 also includes task pane 200. An aspect of task pane 200 permits the user to edit and easily access the user's bookmarks 210. Bookmarks 210 may include, but are not limited to, listings of traditional bookmarks 212 and the user's predefined start groups 215. When the user clicks on, selects, or otherwise interacts with a bookmark from bookmarks 210, such as bookmark 218 which corresponds to a start group entry, the currently active tab or window within browsing application 1 can load the selected bookmark.

Task pane 200 can also allow the user to edit the bookmarks listed therein, including those listed in start groups 215. Such editing may include, but is not limited to, dragging and dropping bookmarks into and out of start groups category 215, and dragging and dropping bookmarks within start groups category 215 to change the order in which the pages are loaded into browsing application 1. By right-clicking or otherwise interacting with a bookmark, the user can also edit the bookmark's properties, including, without limitation, the bookmark's name as it appears in task pane 200, the underlying URL or other link, the display order, and other such bookmark properties.

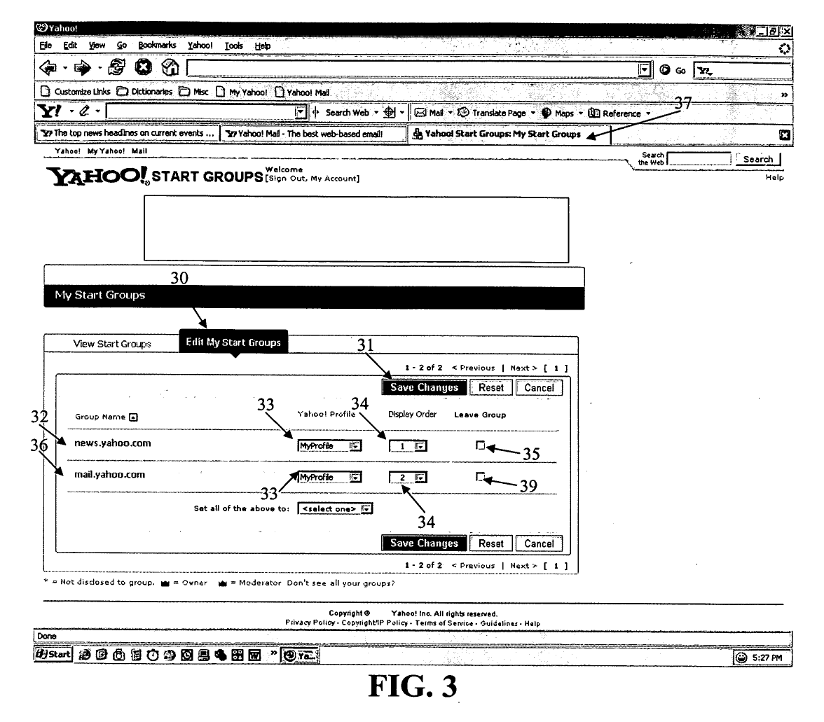

FIG. 3 is a screen capture of an exemplary network browsing application user interface through which start group properties can be edited. In FIG. 3, individual members of the user's start groups 32 and 36 are listed within Edit My Start Groups region 30. In the illustrated embodiment, the user can remove a start group by checking the appropriate check box 35 or 39, and clicking Save Changes button 31 or otherwise indicating to browsing application 1 that the changes should be saved. Where browsing application 1, the networking environment in which browsing application 1 is operating, or an intermediary service such as the well known Yahoo! suite of services, permits the user to maintain multiple profiles, an embodiment also allows the user to edit the user profile with which a given start group is associated by selecting the appropriate profile from profile list 33. An embodiment also allows the user to edit the start group display order by selecting an appropriate display order from list box 34. In an embodiment, where the user selects a new start group display order, all start group entries having a number equal to or greater than the selected display order have their display order incremented by one.

In an embodiment, a list of the user's start group pages may be maintained locally on client 18. Such a list may be the primary list, or the copy maintained locally on client 18 may be a cached copy of the most recent list received from a central server. In a server-based embodiment embodiment, a list of the user's start group pages may be stored on a central server so that the list can be made available to the user independent of the machine the user is using or the user's location.

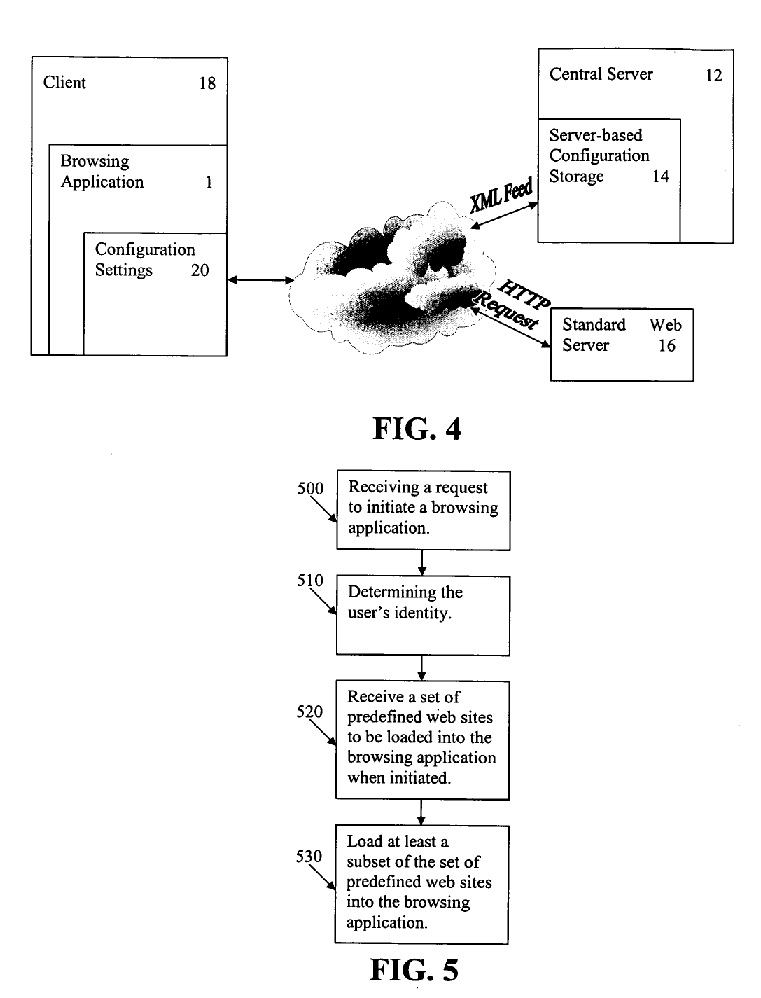

Referring to FIG. 4, in this respect, browsing application 1 runs on or in a client 18 and preferably includes processes which request and receive configuration settings 20 from a central server 12 which stores these settings in server-based configuration storage 14. Central server 12 may be a single physical device or a plurality of devices sharing the workload and/or responsibilities typically associated with a server. By way of example, without limitation, central server 12 may be a plurality of servers which share or have access to at least one database in which server-based configuration storage 14 is stored. Such a database may store the configuration settings as one or more flat files, in a spreadsheet or other table, or in a for accessible through one or more database servers, such as SQL Server published by Microsoft Corporation, or MySQL published by the MySQL AB of Sweden. Each of central servers 12 in this example may be accessed by various clients 18 or browsing applications 1 in round robin fashion or through the use of other such network load sharing techniques.

Configuration settings 20 received from central server 12 can include a listing of the pages in the user's start group, as well as additional information, such as, without limitation, the user's bookmark list, the user's friends list(s) for one or more chat programs, the E-mail addresses for the user's friends, and the like. An example of such configuration settings is illustrated in the XML feed shown in Appendix A. As is discussed in detail above, browsing application 1 can acquire such configuration settings at startup, runtime, login, or other appropriate time. This information can be parsed by browsing application 1 or a plug-in or other enhancement to browsing application 1 such that the start groups are appropriately displayed when browsing application 1 loads and/or when requested by the user.

The user can be identified to central server 12 through a variety of well known means, such as, without limitation, based on credentials supplied by the operating system or client 18 in which browsing application 1 is running, or by an application associated with the operating system or client 18. Examples of such applications associated with the operating system include, without limitation, the well known Yahoo! Pager and Yahoo! Music Engine programs. The operating system, client 18, or application associated with the operating system may authenticate the user based on a username and password, biometric identifier, or other authorization information against a local server or against central server 12. Once authenticated, the user's credentials can be used to access server-based configuration storage 14 on central server 12. The user's credentials can be authenticated periodically based on events or based on time. By way of example, without limitation, the first time in each calendar day that a user initiates browsing application 1, the user may be asked to supply a username and password.

In an embodiment, a minimum set of web pages to be loaded into browsing application 1 may be defined by a provider of browsing application 1, the provider of client 18, a network service provider, the user's employer, a systems administrator, or other such entities.

FIG. 5 illustrates a method through which a network browsing application can initiate and load the user's start groups. In block 500, a request is received to initiate a browsing application. In block 510, the user's identity is determined, such that an individualized set of start groups can be received. In block 520, the start group, or set of web sites, is received, and in block 530, at least a subset of the set of web sites is loaded into the network browsing application.

While embodiments have been particularly shown and described herein, it will be understood by those skilled in the art that various changes in form and details may be made therein without departing from the spirit and scope of the invention.

We claim:

1. A method of initializing the contents of a browsing application running on a client, the method comprising:
receiving from a user a request to initiate a browsing application;
receiving a set of predefined web sites to be loaded into the browsing application; and
loading at least a subset of the set of predefined web sites into the browsing application.

2. The method of claim 1, wherein the set of predefined web sites is received from the client.

3. The method of claim 1, wherein the set of predefined web sites is received from a central server.

4. The method of claim 3, further comprising compiling a set of predefined web sites to be loaded into the browsing application as an XML data feed.

5. The method of claim 1, wherein the set of predefined web sites are loaded into the browsing application as a plurality of tabs within the browsing application.

6. The method of claim 1, wherein the set of predefined web sites are loaded into the browsing application as a plurality of browsing application windows.

7. The method of claim 1, further comprising determining an identity for the user.

8. The method of claim 7, wherein the set of predefined web sites are specific to the user.

9. The method of claim 8, wherein the set of predefined web sites is defined by the user.

10. The method of claim 7, wherein the identity of the user is determined from the client in which the browsing application is running.

11. The method of claim 7, wherein the identity of the user is determined from an application associated with the browsing application.

12. The method of claim 1, further comprising:
receiving from a user a request to load the plurality of predefined web sites into the browsing application; and
loading at least a subset of the plurality of predefined web sites into the browsing application.

13. A method of loading a plurality of web sites into a browsing application running on a client, the method comprising:
receiving a plurality of predefined web sites to be loaded into the browsing application;
receiving from a user a request to load the plurality of predefined web sites into the browsing application; and
loading at least a subset of the plurality of predefined web sites into the browsing application.

14. The method of claim 13, wherein the set of predefined web sites is received from the client.

15. The method of claim 13, wherein the set of predefined web sites is received from a central server.

16. The method of claim 15, further comprising compiling a set of predefined web sites to be loaded into the browsing application as an XML data feed.

17. The method of claim 13, wherein the set of predefined web sites are loaded into the browsing application as a plurality of tabs within the browsing application.

18. The method of claim 13, wherein the set of predefined web sites are loaded into the browsing application as a plurality of browsing application windows.

19. The method of claim 13, further comprising determining an identity for the user.

20. The method of claim 19, wherein the set of predefined web sites are specific to the user.

21. The method of claim 20, wherein the set of predefined web sites is defined by the user.

22. The method of claim 19, wherein the identity of the user is determined from the client in which the browsing application is running.

23. The method of claim 19, wherein the identity of the user is determined from an application associated with the browsing application.

24. A computer-readable storage medium containing a set of instructions for a general purpose computer for initializing the contents of a browsing application running on a client, comprising:
code for receiving from a user a request to initiate a browsing application;
code for receiving a set of predefined web sites to be loaded into the browsing application; and
code for loading at least a subset of the set of predefined web sites into the browsing application.

25. The method of claim 24, wherein the set of predefined web sites is received from the client.

26. The method of claim 24, wherein the set of predefined web sites is received from a central server.

27. The method of claim 26, further comprising code for compiling a set of predefined web sites to be loaded into the browsing application as an XML data feed.

28. The method of claim 24, wherein the set of predefined web sites are loaded into the browsing application as a plurality of tabs within the browsing application.

29. The method of claim 24, wherein the set of predefined web sites are loaded into the browsing application as a plurality of browsing application windows.

30. The method of claim 24, further comprising code for determining an identity for the user.

31. The method of claim 30, wherein the set of predefined web sites are specific to the user.

32. The method of claim 31, wherein the set of predefined web sites is defined by the user.

33. The method of claim 30, wherein the identity of the user is determined from the client in which the browsing application is running.

34. The method of claim 30, wherein the identity of the user is determined from an application associated with the browsing application.

35. The method of claim 24, further comprising:
code for receiving from a user a request to load the plurality of predefined web sites into the browsing application; and
code for loading at least a subset of the plurality of predefined web sites into the browsing application.

36. A user interface for facilitating the transfer of content between a plurality of devices, comprising:
first code for presenting a network browsing application on a first device, wherein the first code permits a user of the network browsing application to identify a web site to be added to a start groups list;
second code for causing the web site to be added to the start groups list associated with the user; and,
third code for causing the network browsing application to load at least a list of the web sites contained in the start groups list associated with the user, whereby the user can edit the contents of the start groups list.

37. The method of claim 36, wherein the edits the user can make include removing at least one web site from the start groups list.

38. The method of claim 36, wherein the edits the user can make include reordering the web sites in the start groups list.

39. The method of claim 38, wherein the reordering is performed by dragging and dropping.

40. The method of claim 36, wherein the edits the user can make include renaming at least one web site from the start groups list.

41. The method of claim 36, wherein the edits the user can make include changing the URL associated with a web site from the start groups list.

42. The method of claim 36, wherein the edits the user can make include adding at least one web site to the start groups list.

43. The method of claim 36, wherein the edits the user can make include removing at least one web site from the start groups list, reordering the web sites in the start groups list, changing the URL associated with a web site from the start groups list, and adding at least one web site to the start groups list.

44. The method of claim 36, wherein the user cannot remove at least a subset of the start groups list.

45. The method of claim 36, wherein the user cannot reorder at least a subset of the start groups list.
